(19) United States
(12) Patent Application Publication
(10) Pub. No.: US 2003/0091400 A1
(43) Pub. Date: May 15, 2003

(54) Cutterhead with regrindable inserts

(76) Inventors: Philippe Turcot, Mont St-Hilaire (CA); Gabriel Fafard, St-Hubert (CA)

Correspondence Address: OGILVY RENAULT, 1981 MCGILL COLLEGE AVENUE, SUITE 1600, MONTREAL, QC, H3A2Y3, CA

(21) Appl. No.: 09/987,492

(22) Filed: Nov. 15, 2001

(51) Int. Cl. B23B 27/00; B26D 1/12

(52) U.S. Cl. 407/30; 407/62

(57) ABSTRACT

A rotary cutting tool wherein the positioning of a cutting insert is accomplished via a frontal reference surface instead of a backing reference surface. This is done by modifying the regrindable insert to include a pair of lateral shoulders that must be seated on the reference surface to ensure proper positioning of the insert relative to the cutting tool. The insert is retained against centrifugal dislodgment by the frontal reference surface during rotation of the tool, thereby permitting the latter to be operated at higher rotational speeds. The use of a frontal reference surface also eliminates the need of having to reposition the cutting tool vis-à-vis the workpiece between each sharpening operation of the cutting insert.

### BACKGROUND OF THE INVENTION

1. Field of the Invention

The present invention generally relates to rotary cutting tools and, more particularly, to rotary cutting tools equipped with regrindable inserts.

2. Description of the Prior Art

The conventional manner of positioning a chisel or cutting insert on the insert holder of a rotary cutter, such as a router bit, a milling cutter or a planer head, is by abutting a precision ground surface located on the rear and side edges of the insert against a precision ground backing reference surface provided on the insert holder's body. One of the shortcomings of such a system is that the entire cutting tool must be repositioned relative to the workpiece every time the cutting edge of the insert is sharpened. This adjustment compensates for the amount of material removed from the insert's worn edge. This adjustment is effected so that the workpieces being machined are in dimensional tolerance, one to the other from one work cycle to the next.

Furthermore, it has been determined that it would be advantageous to integrate an insert positioning system preventing centrifugal dislodgment of the insert when spinning the insert holder.

### SUMMARY OF THE INVENTION

It is therefore an aim of the present invention to provide a new cutting insert positioning system that is convenient to use.

It is also an aim of the present invention to provide a new cutting insert positioning system able to offer resistance to the dislodgment of a cutting insert caused by centrifugal forces acting thereon while the insert holder is being rotated.

It is a further aim of the present invention to eliminate the need to reposition a rotary cutting tool relative to a workpiece, every time a cutting insert is sharpened.

Hence, the present invention will reference the insert from the front or profiled side of the insert instead of a surface located at the rear of the insert. This is realized by incorporating lateral shoulders onto the regrindable inserts enabling them to be seated and referenced to the cutter's body.

When it will be deemed necessary to service the worn edge of an insert, the insert will be removed from the insert holder and ground so as to restore the profile and to remove an equivalent amount of material from the positioning shoulders thereof. The insert will then be placed back onto the insert holder and the precision ground frontal reference surface will locate the insert's cutting edge in exactly the same spot it previously vacated. This will enable the operator to place the cutting tool onto the spindle or into the holder without having to readjust the position of either in relation to the workpiece.

In accordance with a further general aspect of the present invention, there is provided a rotary cutting tool. The tool comprises a cutting insert having a forwardly projecting end portion defining a cutting edge and a pair of shoulders extending laterally outwardly relative to the forwardly projecting end portion. The tool further includes an insert mounting member having an axis of rotation and defining a seat for removably receiving the cutting insert. The seat is provided at a front end thereof with a pair of spaced-apart positioning members for receiving the forwardly projecting end portion of the cutting insert therebetween with the shoulders resting on the positioning members so as to provide centripetal locking of the cutting insert in the seat during rotation of the insert mounting member about its axis of rotation. A securing structure is also provided for releasably securing the cutting insert in the seat.

In accordance with a still further general aspect of the present invention, there is provided a cutting insert setting system for a rotary cutting tool, said cutting insert setting system comprising an insert having a regrindable front surface defining a cutting edge, an insert mounting member having an axis of rotation and defining a seat for receiving said insert, said seat defining at a periphery of said insert mounting member a frontal reference structure against which said front surface of said regrindable insert abuts to set the position of said insert and resist centrifugal dislodgment thereof from said seat during rotation of said insert mounting member.

In accordance with a further general aspect of the present invention, there is provided a cutting insert for use on a rotary cutting tool, comprising a plate-like member having a forwardly projecting end portion defining a cutting edge and a pair of positioning shoulders extending laterally outwardly on opposed sides of said front cutting edge.

In accordance with a further general aspect of the present invention, there is provided a method of setting a cutting insert on an insert holder of a rotary cutting tool, the method comprising the steps of: providing an insert holder having a seat defining a frontal reference surface, providing a cutting insert having a cutting edge and a pair of shoulders, positioning said cutting insert in said seat by abutting said shoulders against said frontal reference surface, and releasably securing said cutting insert in position.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a schematic elevation view of a rotary cutting tool in accordance with a first embodiment of the present invention; and

FIG. 2 is an enlarged schematic elevation view of the cutting tool of FIG. 1;

### DESCRIPTION OF THE PREFERRED EMBODIMENTS

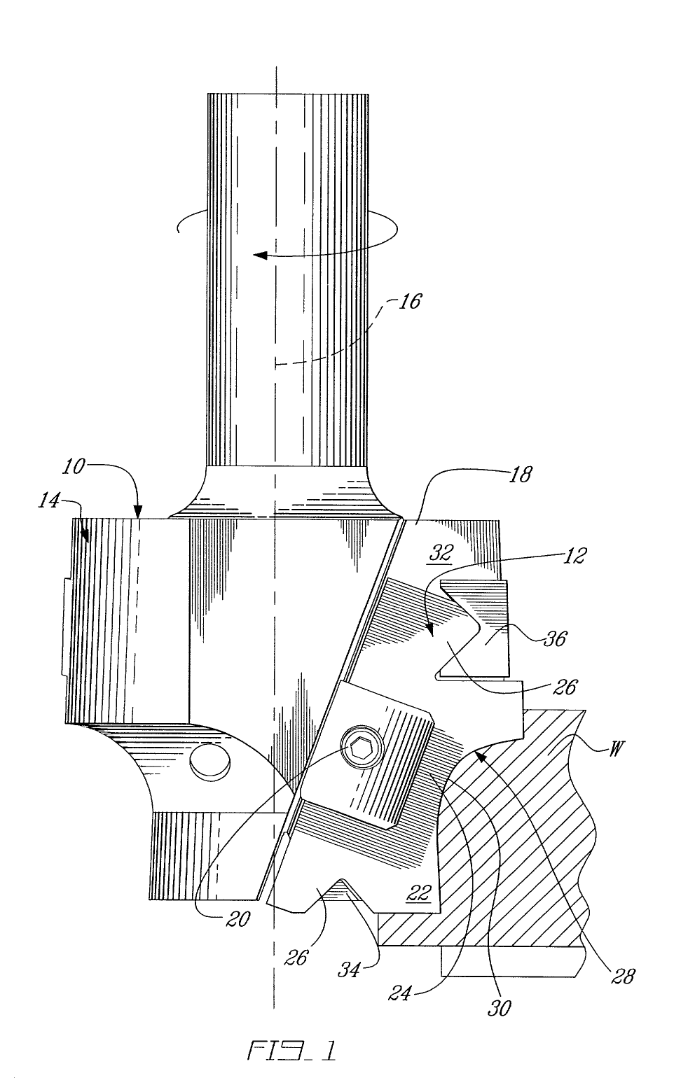

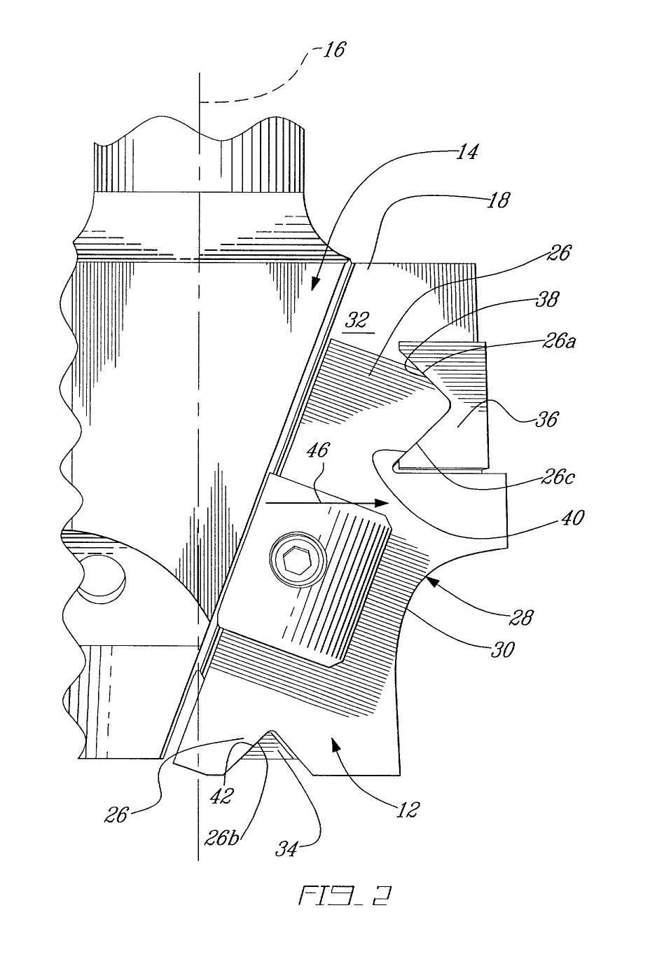

Referring now to the drawings, a cutting tool 10 for processing a workpiece W in accordance with the present invention comprises a number of cutting inserts, one of which is shown at 12 in FIGS. 1 and 2, carried by a rotary insert mounting member or holder 14 having an axis of rotation 16 about which the holder 14 is driven. The cutting tool is intended for machining solid woods, engineered woods, plastics, composites and non-ferrous metals.

A number of circumferentially spaced-apart insert seats, one of which is shown at 18 in FIGS. 1 and 2, are defined at the periphery of the holder 14 for receiving corresponding cutting inserts. The cutting insert 12 is releasably secured in the seat 18 by means of a conventional fixing mechanism, such as a clamping screw 20 so as to provide circumferential blocking.

The cutting insert 12 is preferably made of rigid carbide, diamond or other material capable of cutting. The insert 12 is provided in the form of a plate having parallel planar side faces 22 shaped to define a forwardly projecting end portion 24 and a pair of lateral shoulders 26. The shoulders 26 and the forwardly projecting end portion 24 are delimited at the front by the frontal surface 28 of the cutting insert 12. A cutting edge 30 of a desired profile is provided at the frontal surface 28 between the shoulders 26 for engaging the workpiece W and cut the same.

The seat 18 has a flat bottom wall 32 against which one of the planar side faces 22 of the insert 12 is pressed by the compression force exerted by the screw 20 on the opposite side face 22. A pair of abutment members 34 and 36 extends at right angles from the bottom wall 32 at a front end of the seat 18. As best seen in FIG. 2, the abutment member 36 includes first and second angular abutment surfaces 38 and 40. The abutment member 34 includes a single abutment surface 42. The abutment surfaces 38, 40 and 42 are arranged to provide axial and radical restraint of the insert 12 in the seat 18. According to a preferred embodiment of the present invention, the abutment members 34 and 36 consist of blocks integrally machined in the body of the holder 14. Alternatively, one of the abutment members 34 and 36 could be provided in the form of separately machined blocks fixed to the body of the holder 14.

The positioning of the insert 12 on the bottom wall 32 of the seat 18 is effected by abutting the shoulders 26 against the abutment surfaces 38, 40 and 42 with the forwardly projecting end portion 24 extending between the spaced-apart abutment members 34 and 36. The abutment surfaces 38, 40 and 42 form a frontal reference surface for setting the position of the insert 12 in the seat 18. The frontal reference surface provides axial and radial restraint for the insert 12. Once the insert 12 has been properly positioned in the seat 18, the screw 20 is tightened to secure the insert 12 in position. In addition of being a positioning aid, the abutment surfaces 38, 40 and 42 advantageously act as a centripetal lock to prevent dislodgment of the insert 12 under the centrifugal force 46 during rotation of the holder 14 about axis 16. This allows operating the cutting tool at higher speeds.

When the insert 12 requires a subsequent sharpening, the clamping screw 20 is loosened and the insert 12 is removed from the holder 14. Then, by grinding a given thickness of material from the cutting edge 30, the cutting edge is restored. During the grinding operation, the abutment surfaces 26a, 26b and 26c formed by the shoulders 26 are also ground so as to remove therefrom the same thickness of material that has been removed along the cutting edge 30. The insert 12 is thereafter repositioned in the seat 18 by abutting the newly machined shoulders 26 against the abutment surfaces 38, 42 and 40. The cutting tool 10 does not have to be repositioned in relation to the workpiece W since the removal of material from the insert frontal abutment surfaces 26a, 26b and 26c compensates for the removal of material removed from the worn cutting edge 30. That is to say, the positioning of the cutting edge 30 relative to the frontal reference surface of the seat 18 remains constant at all time, thereby providing for the production of parts of uniform profile without having to readjust the position of the cutting tool 10 after every subsequent sharpening of the cutting inserts.

1. A rotary cutting tool, comprising a cutting insert having a forwardly projecting end portion defining a cutting edge and a pair of shoulders extending laterally outwardly relative to said forwardly projecting end portion, an insert mounting member having an axis of rotation, said insert mounting member defining a seat for removably receiving said cutting insert, said seat being provided at a front end thereof with a pair of spaced-apart positioning members for receiving said forwardly projecting end portion of said cutting insert therebetween with said shoulders resting on said positioning members so as to provide centripetal locking of said cutting insert in said seat during rotation of said insert mounting member about said axis of rotation thereof, and a securing structure for releasably securing said cutting insert in said seat.

2. A tool as defined in claim 1, wherein said positioning members are engaged with said cutting insert on at least two different planes.

3. A tool as defined in claim 2, wherein said two planes are arranged relative to said axis of rotation to provide axial and radial restraint of said cutting insert.

4. A tool as defined in claim 1, wherein at least one of said positioning members has two abutment surfaces for engagement with corresponding surfaces of one of said shoulders to restrain said insert against axial and radial translation.

5. A tool as defined in claim 4, wherein another one of said positioning member is adapted to block said insert against rotation.

6. A tool as defined in claim 1, wherein said cutting insert is provided in the form of a plate-like member having a pair of planar and parallel side faces, and wherein said securing structure exerts a compression force against one of said side faces in a direction normal thereto.

7. A tool as defined in claim 1, wherein a plurality of seats are distributed about a periphery of said insert mounting member for releasably receiving corresponding cutting inserts.

8. A cutting insert setting system for a rotary cutting tool, said cutting insert setting system comprising an insert having a regrindable front surface defining a cutting edge, an insert mounting member having an axis of rotation and defining a seat for receiving said insert, said seat defining at a periphery of said insert mounting member a frontal reference structure against which said regrindable front surface of said insert abuts to set the position of said insert and resist centrifugal dislodgment thereof from said seat during rotation of said insert mounting member.

9. A system as defined in claim 8, wherein said regrindable front surface includes an abutment surface extending laterally outwardly relative to said cutting edge.

10. A system as defined in claim 9, wherein said abutment surface is formed by two shoulders disposed on opposed sides of said cutting edge.

11. A system as defined in claim 8, wherein said frontal reference structure includes at least two abutment surfaces extending in different planes for engagement with corresponding regrindable abutment surfaces on said insert.

12. A system as defined in claim 11, wherein said at least two abutment surfaces of said frontal reference structure are arranged relatively to said axis of rotation to provide axial and radial restraint of said insert.

13. A system as defined in claim 12, wherein said at least two abutment surfaces of said frontal reference structure includes first, second and third abutment surfaces for blocking the insert against translation in two different directions and against rotation about an axis normal to said directions.

14. A system as defined in claim 13, wherein said second and third abutment surfaces are provided on a first positioning member, whereas said first abutment member is provided on a second positioning member, said cutting edge extending between said first and second abutment members.

15. A cutting insert for use on a rotary cutting tool, comprising a plate-like member having a forwardly projecting end portion defining a cutting edge and a pair of positioning shoulders extending laterally outwardly on opposed sides of said front cutting edge.

16. A method of setting a cutting insert on an insert holder of a rotary cutting tool, the method comprising the steps of: providing an insert holder having a seat defining a frontal reference surface, providing a cutting insert having a cutting edge and a pair of shoulders, positioning said cutting insert in said seat by abutting said shoulders against said frontal reference surface, and releasably securing said cutting insert in position.

17. A method as defined in claim 16, further comprising the steps of removing said cutting insert from said seat, sharpening said cutting insert by removing a desired thickness of material from said cutting edge, removing the same thickness of material from said shoulders, positioning said cutting insert back in said seat with said shoulders abutting against said frontal reference surface.

18. A method as defined in claim 16, wherein said frontal reference surface includes radial and axial restraining segments, and wherein the step of positioning the cutting insert in the seat is effected by abutting said shoulders against said radial and axial restraining segments so as to provide centripetal locking of the cutting insert in the seat during rotation of the insert holder about an axis of rotation thereof.
